(19) United States
(12) Patent Application Publication
(10) Pub. No.: US 2010/0070603 A1
(43) Pub. Date: Mar. 18, 2010

(54) Method and Apparatus for Unifying Interfaces at Content Sources and Content Distributors

(76) Inventors: Eran Moss, Uccle (BE); Dave C. Robinson, Wiltshire (GB); Marc Verhoeyen, Oudenaarde (BE)

Correspondence Address: WALL & TONG, LLP/;ALCATEL-LUCENT USA INC., 595 SHREWSBURY AVENUE, SHREWSBURY, NJ, 07702, US

(21) Appl. No.: 12/212,686

(22) Filed: Sep. 18, 2008

(51) Int. Cl. G06F 15/16

(52) U.S. Cl. 709/207

(57) ABSTRACT

The invention includes a method and apparatus for facilitating distribution of content from content sources to content distributors. In one embodiment, a method includes receiving meta-data associated with a content item available from the content source and propagating a notification regarding availability of the content item from the content source, where the notification comprises at least a portion of the associated meta-data. The meta-data is received from a content source from which the content item is available. The notification message for the content item, including at least a portion of the meta-data is propagated toward a content distributor, thereby enabling the content distributor to obtain a copy of the content item for use in serving requests for the content item originating from end users served by the content distributor.

### FIELD OF THE INVENTION

The invention relates to the field of communication networks and, more specifically, to distribution of content from content sources to end users via content distributors.

### BACKGROUND OF THE INVENTION

In an Internet-based telecommunications environment, the numbers of content owners and aggregators and content distributors continues to grow. In this environment, content owners and aggregators are confronted with the need to establish relationships with increasing numbers of different content distributors in order to increase the distribution base of their content, and, similarly, content distributors are confronted with the need to establish relationships with increasing numbers of different content owners and aggregators in order to satisfy the demands of their users for an increasing variety of content. Disadvantageously, however, existing forms of interaction between content owners and aggregators and content distributors are complex and, thus, costly.

### SUMMARY OF THE INVENTION

Various deficiencies in the prior art are addressed by a method and apparatus for facilitating distribution of content from content sources to content distributors. In one embodiment, a method includes receiving meta-data associated with a content item available from the content source and propagating a notification regarding availability of the content item from the content source, where the notification comprises at least a portion of the associated meta-data. The meta-data is received from a content source from which the content item is available. The notification message for the content item, including at least a portion of the meta-data is propagated toward a content distributor, thereby enabling the content distributor to obtain a copy of the content item for use in serving requests for the content item originating from end users served by the content distributor.

### BRIEF DESCRIPTION OF THE DRAWINGS

The intent of the present invention can be readily understood by considering the following detailed description in conjunction with the accompanying drawings, in which:

FIG. 1 depicts a high-level block diagram of a communication network;

FIG. 2 depicts a method for facilitating distribution of content from content sources to content distributors;

FIG. 3 depicts a method for storing a content item available from a content source;

FIG. 4 depicts a method for facilitating delivery of content usage information from content distributors to content sources;

FIG. 5 depicts the communication network of FIG. 1, illustrating an embodiment of a method for delivering a content item to an end user;

FIG. 6 depicts the communication network of FIG. 1, illustrating an embodiment of a method for delivering a content item to an end user; and

FIG. 7 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

A content distribution capability is provided. The content distribution functions depicted and described herein facilitate distribution of content from content sources (e.g., content owners, content aggregators, and the like) to content distributors (e.g., local content distributors, global content distributors, and the like). The content distribution functions depicted and described herein facilitate distribution of content usage information from content distributors to content sources. The content distribution functions depicted and described herein simplify interactions between content sources and content distributors. The content distribution functions depicted and described herein improve the quality-of-service of end users requesting content and, further, reduce consumption of network resources required to delivery requested content to end users.

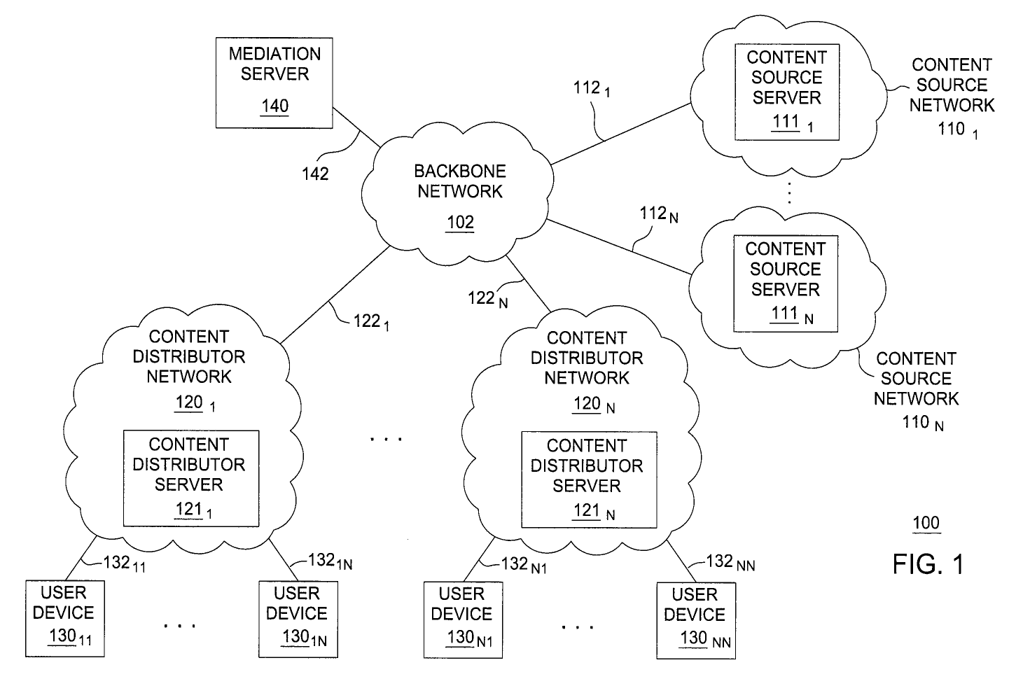

FIG. 1 depicts a high-level block diagram of a communication network. As depicted in FIG. 1, a communication network 100 includes a backbone network (BN) 102 facilitating communications for a plurality of content source networks (CSNs) 110₁-110_{N} (collectively, CSNs 110), a plurality of content distribution networks (CDNs) 120₁-120_{N} (collectively, CDNs 120), and a mediation server (MS) 140. The CSNs 110₁-110_{N} communicate with BN 102 via a respective plurality of communication paths (CPs) 112₁-112_{N} (collectively, CPs 112). The CDNs 120₁-120_{N} communicate with BN 102 via a respective plurality of communication paths (CPs) 122₁-122_{N} (collectively, CPs 122). The MS 140 communicates with BN 102 via a communication path (CP) 142.

The communication network 100 facilitates distribution of content from CSNs 110 to CDNs 120 for ultimate distribution to end users. The content may include any content adapted for being provided over communication networks. For example, the content may include audio content (e.g., ringtones, songs, albums, and the like), image content (e.g., static images, dynamic images, and the like), video content (e.g., television programs, movies, and the like), multimedia content, software, and the like, as well as various combinations thereof.

The CSNs 110 are networks operated by sources of content. The sources of content may include content owners, content aggregators, and the like, as well as various combinations thereof.

A content owner is an entity that owns content for distribution to end users. A content owner may create the content or otherwise obtain rights to the content. For example, content owners may include entities, such as businesses, organizations, and the like (e.g., Warner Music, Major League Baseball, MTV Networks, Disney, and like entities which own content which may be distributed to end users).

A content aggregator is an entity that aggregates content from multiple content sources for distribution to end users. For example, content aggregators may include companies such as Joost, Veoh, Reeltime.com, Hulu, Zattoo, Babelgum, TVU Networks Corporation, LiveStation, and the like. of content for distribution to end users.

As depicted in FIG. 1, CSNs 110₁-110_{N} include a respective plurality of content source servers (CSSs) 111₁-111_{N} (collectively, CSSs 111). The CSSs 111 include systems capable of storing content items and propagating content items toward other devices (e.g., toward content distributor systems, end user devices, and the like). The CSSs 111 may store content items in any manner. The CSSs 111 may include internal storage capabilities and/or may store and access content items remotely in other storage devices located within or beyond respective CSNs 110. The CSSs 111 may propagate content items in any manner (e.g., using any transmission capabilities and protocols which may be used for propagating content items).

The CSNs 110 may utilize any communication technologies adapted for use in storing content and distributing content to content distributors and end users. For example, CSNs 110 may utilize different network elements (e.g., servers, routers, switches, and the like), networking capabilities (e.g., fiber optics, cable, and the like), protocols, and the like, as well as various combinations thereof. The CSNs 110 may be local area networks (LANs), campus area networks (CANs), wide area networks (WANs), and the like. The CSNs 110 may be public or private networks.

The CDNs 120 are networks operated by distributors of content. The content distributors may include local content distributors and global content distributors. The CDNs 120 may include wireline and/or wireless capabilities. For example, local content distributors may include national or regional telecommunications operators, such as AT&T, British Telecom, France Telecom, and the like. For example, global content distributors may include content distributors using global content distribution network technologies, such as Akamai, BitGravity, LimeLight Networks, and the like. The CDNs 120 may be operated by various other content distributors.

As depicted in FIG. 1, CDNs 120₁-120_{N} include a respective plurality of content distribution servers (CDSs) 121₁-121_{N} (collectively, CDSs 121). The CDSs 121 include any systems capable of storing and distributing content items. The CDSs 121 may store content items in any manner. The CDSs 121 may include internal storage capabilities and/or may store and access content items remotely in other storage devices located within or otherwise associated with respective CDNs 120. The CDSs 121 may distribute content items in any manner, which may depend on the type of content items being distributed (e.g., using content delivery techniques to distribute images, using content streaming protocols for streaming television programs and movies, and the like).

The CDNs 120 may utilize any communication technologies adapted for use in storing content and distributing content to end users. The CDNs 110 may be public or private networks.

The CDNs 120₁-120_{N} support communications for user devices, such as processing/propagating requests for content received from user devices, distributing content for delivery to user devices, and the like, as well as various combinations thereof. As depicted in FIG. 1, each of the CDNs 120ₓ serves a plurality of user devices (UDs) 130ₓ₁-130_{xN} (collectively, UDs 130ₓ) via a plurality of communication paths (CPs) 132ₓ₁-132_{xN} (collectively, CPs 132ₓ), respectively. The CDN 120₁ serves UDs 130₁₁-130_{1N} (collectively, UDs 130₁) via respective CPs 132₁₁-132_{1N} (collectively, CPs 130₁), and the CDN 120_{N} serves UDs 130_{N1}-130_{NN} (collectively, UDs 130_{N}) via respective CPs 132_{N1}-132_{NN} (collectively, CPs 130_{N}). The UDs 130₁-130_{N} are referred to collectively as UDs 130. The CPs 132₁-132_{N} are referred to collectively as CPs 132.

The UDs 130 are devices from which users may request content items and by which users may review content items delivered by CDNs 120. For example, UDs 130 may include user interfaces, such as control interfaces by which users may initiate requests for content items and control presentation of delivered content items (e.g., remote controls, keyboards, keypads, touch screens, and similar interfaces), content presentation interfaces by which delivered content items may be presented to the user (e.g., speakers, screens, and similar interfaces), and the like, as well as various combinations thereof. For example, UDs 130 may include television systems, computers, cellular phones, and the like.

The MS 140 operates as an interface between content sources and content distributors in a manner for facilitating distribution of content to end users. The MS 140 controls which content distributors receive which CS-distributed information, thereby facilitating distribution of content items from content sources to content distributors. The MS 140 controls which content sources receive which CD-distributed information, thereby facilitating reporting of content usage information from content distributors to content sources. In some embodiments, MS 140 may also facilitate delivery of content items to user devices. The MS 140 may provide various other functions depicted and described herein.

The CSSs 111 register with MS 140 via a first interface supported by MS 140 for communications with content source systems. The CSSs 111 may register with MS 140 in any manner. The MS 140 may initiate registration of a CSS 111, or a CSS 111 may initiate registration with MS 140. The MS 140 may store registration information for each CSS 111 that registers with MS 140. The registration information may include information enabling MS 140 to communicate with the CSS 111 which registers with MS 140. In this manner, a CSS 111 may establish a relationship with MS 140 that is adapted for enabling MS 140 to provide notifications to one or more CDSs 121 regarding content that is available at the CSS 111 (i.e., for one or more CDSs 121 operating as content distributors for the CSS 111). This obviates the need for CSSs 111 to manage determinations regarding distribution of content items to CDSs 121.

The CDSs 121 register with MS 140 via a second interface supported by MS 140 for communications with content distribution systems. The CDSs 121 may register with MS 140 in any manner. The MS 140 may initiate registration of a CDS 121, or a CDS 121 may initiate registration with MS 140. The MS 140 may store registration information for each CDS 121 that registers with MS 140. The registration information may include information enabling MS 140 to communicate with the CDS 121 which registers with MS 140. In this manner, a CDS 121 may establish a relationship with MS 140 that is adapted for enabling MS 140 to provide notifications to the CDS 121 regarding content that is available at one or more CSSs 111 for which the CDS 121 operates as a content distributor. This obviates the need for CDSs 121 to manage determinations regarding retrieval of content items from CSSs 111.

In this manner, the relationships between CSSs 111 and MS 140 and the relationships between MS 140 and CDSs 121 facilitate distribution of content items from CSSs 111 to CDSs 121. Similarly, the relationships between CDSs 121 and MS 140 and the relationships between MS 140 and CSSs 111 enable CDSs 121 to propagate content usage information toward a single system (namely, MS 140) and, therefore, enable CSSs 111 to receive content usage information from a single system (namely, MS 140), thereby simplifying the normally complex interactions between content distributors and content sources with respect to content usage tracking.

As described herein, MS 140 facilitates distribution of content from CSNs 110 to CDNs 120 for distribution to end users. The content is distributed in the form of content items (e.g., a song, an album, a television program, a movie, a software patch, and the like). A content item has meta-data associated therewith. The meta-data of a content item is defined by the content source of the content item. The MS 140 facilitates distribution of a content item from one of the CSSs 111 to one or more of the CDSs 121. The MS 140 facilitates distribution of a content item from one of the CSSs 111 to one or more of the CDSs 121 using at least a portion of the meta-data associated with the content item.

The MS 140 stores relationship information for business relationships established between content sources and content distributors.

The relationships between content sources and content distributors may be established in any manner, e.g., typically involving business negotiations/agreements between content sources and content distributors. For example, a content source and a content distributor may develop a business agreement whereby the content distributor is one of multiple content distributors allowed to distribute content for the content source. For example, a content source and content distributor may develop a business agreement whereby the content distributor is the exclusive distributor of content for the content source.

The relationships may be established using any granularity. For example, the relationships may be established on one or more of a per-item level, a per-category level (e.g., all sports-related content, all action movies, or any other manner of categorizing content), on a per-format level (e.g., all audio content, all television shows, all movies, or any other format of content), and the like, as well as various combinations thereof. The relationships may be established using any other types of granularity in defining the relationship between the content sources and the content distributors.

The relationship information for a relationship established between a content source and a content distributor may include any information which may define the established relationship. The relationship information may include one or more of identification of the content from the content source to be distributed by the content distributor, one or more rules defining the manner in which the content distributor is to distribute the content (e.g., based on geographic location such as in geoblocking, according to quality-of-service thresholds, and the like), and the like, as well as various combinations thereof.

The relationship information may be provided to MS 140 in any manner. In one embodiment, for example, the relationship information may be provided to MS 140 from the content sources (e.g., automatically from one or more systems of the associated content source network and/or in any other suitable manner in which such information may be provided). In one embodiment, for example, the relationship information may be provided to MS 140 from the content distributors (e.g., automatically from one or more systems of the associated content distributor network and/or in any other suitable manner in which such information may be provided).

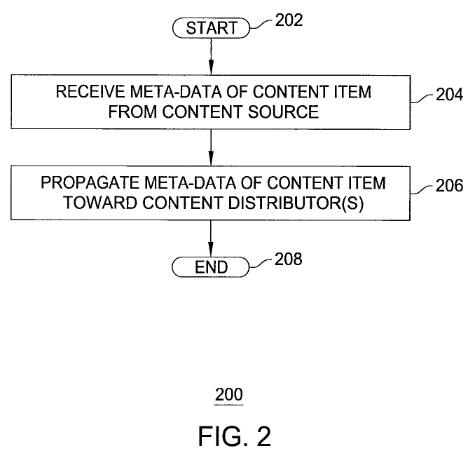

The MS 140 facilitates distribution of a content item from one of the CSSs 111 to one or more of the CDSs 121. The MS 140 receives meta-data for the content item from the one of the CSSs 111 from which the content item is available. The MS 140 selects one or more of the CDSs 121 which should be notified of the availability of the content item from the one of the CSSs 111. The MS 140 propagates a notification toward the selected one(s) of the CDSs 121 which should be notified of the availability of the content item. The selected one(s) of the CDSs 121 may then obtain the content item from the one of the CSSs 111 for storage on the selected one(s) of the CDSs 121, thereby enabling improved distribution of the content item to UDs 130 associated with the selected one(s) of the CDSs 121. The content distribution functions supported by MS 140 may be better understood by way of reference to FIG. 2.

FIG. 2 depicts a method according to one embodiment of the present invention. Specifically, method 200 of FIG. 2 includes a method performed by a mediation server for facilitating distribution of a content item from a content source to one or more content distributors. Although primarily depicted and described as being performed serially, at least a portion of the steps of method 200 may be performed contemporaneously, or in a different order than depicted and described with respect to FIG. 2. The method 200 begins at step 202 and proceeds to step 204.

At step 204, the mediation server receives meta-data associated with the content item.

The meta-data for a content item may include one or more of an identifier of the content item, a title of the content item, a location of the content item (e.g., a network location from which the content item may be retrieved, e.g., a URL), an availability of the content item, content-related meta-data for the content item, a geoblocking indicator for the content item (e.g., the content item is only available for distribution within the United States), a popularity indicator for the content item, and the like, as well as various combinations thereof. The meta-data may include any other similar information associated with a content item.

The mediation server may receive the meta-data in any manner.

In one embodiment, the content source of the content item may push the meta-data to the mediation server. For example, in response to one or more trigger conditions detected by a content source server, the content source server may retrieve the meta-data for the content item and propagate the meta-data toward the mediation server. For example, trigger conditions may include the content item being made available on the content source server, a indication by the content source that the content item be made available to content distributors, a determination that a popularity rating of the content item satisfies a threshold, one or more time conditions, and the like, as well as various combinations thereof.

In one embodiment, the mediation server may request the meta-data for a content item from the content source of the content item.

In one such embodiment, the content source of the content item may notify the mediation server of the availability of the content item, and, in response, the mediation server may request the meta-data associated with the content item. In one embodiment, for example, the mediation server will always request the meta-data for the content item. In another embodiment, for example, the mediation server may only request the meta-data for the content item if the mediation server determines that there is at least one content distributor that may be interested in being informed about the availability of the content item.

In another such embodiment, the mediation server may periodically poll the content source server to identify newly available content items. As an example, the content source server, in response to receiving a polling message from the mediation server, may identify any newly available content items (e.g., since the last polling message was received), retrieve the meta-data for each newly available content item, and propagate the meta-data toward the mediation server. As an example, the mediation server, in response to identifying a newly available content item, may request that the content source server storing the newly available content item provide the meta-data associated with the content item.

The mediation server may receive the meta-data in any format. The mediation server may receive the meta-data in one or more messages from the content source. The message(s) may be formatted in any manner. For example, the message(s) may use an unstructured format in which all of the meta-data is included within the message as unformatted text. For example, the message(s) may use a structured format in which each type of meta-data (e.g., title, location, and the like) has one or more associated parameters and corresponding parameter values. The meta-data may be propagated using other formats.

At step 206, the mediation server propagates meta-data associated with the content item toward at least a portion of the content distributors.

The mediation server may propagate meta-data associated with the content item to one or more content distributors in any suitable manner.

In one embodiment, the mediation server selects one or more of the content distributors to which the meta-data should be provided.

In one embodiment, the mediation server may select the content distributor(s) to which the meta-data should be provided by identifying each of the available content distributors that has an established relationship with the content source of the content item, and notifying each content distributor having an established relationship with the content source regarding the availability of the content item from the content source.

In one embodiment, the mediation server may select the content distributor(s) to which the meta-data should be provided by identifying each of the available content distributors that has an established relationship with the content source of the content item, and, for each content distributor having an established relationship with the content source, determining whether to notify the content distributor regarding the availability of the content item from the content source.

In one such embodiment, for example, for each content distributor having an established relationship with the content source of the content item, determining whether to notify the content distributor regarding the content item is performed by comparing at least a portion of the meta-data of the content item to information associated with the content distributor (e.g., a content distributor profile or any other similar information associated with the content distributor that is maintained by the mediation server).

In another such embodiment, for example, for each content distributor having an established relationship with the content source of the content item, determining whether to notify the content distributor regarding the content item is performed by comparing at least a portion of the meta-data of the content item to relationship information defining a relationship between the content source and the content distributor.

For example, the meta-data for the content item may indicate that the content item is sports-related. The mediation server may then determine, from relationship information defining a relationship between the content source and the content distributor, that the content distributor is only authorized to distribute non-sports-related content for that content source. As a result, the mediation server will not notify that content distributor regarding the availability of the content item.

For example, the meta-data for the content item may indicate that the content item is approved for distribution only in Japan. The mediation server may then determine, from relationship information defining a relationship between the content source and the content distributor, that the content distributor only distributes content within Japan. As a result, the mediation server will notify that content distributor regarding the availability of the content item.

For example, the meta-data for the content item may indicate that the content item is content from Disney. The mediation server may then determine, from relationship information defining a relationship between the content source and the content distributor, that the content distributor has an established relationship with Disney to distribute Disney content. As a result, the mediation server will notify that content distributor regarding the availability of the content item.

Although, for purposes of clarity, primarily described with respect to simple examples in which only one parameter of meta-data is used to determine whether or not the mediation server notifies a content distributor regarding a content item, it will be understood that combinations of such parameters may be used in a variety of ways in order to determine whether or not the mediation server notifies a particular content distributor regarding a content item.

In another embodiment, the mediation server propagates meta-data for each content item to every content distributor (i.e., without performing any determination as to whether or not the content distributors may be interest in or allowed to store that content item for distribution to end users). In such embodiments, the respective content distributors may then process the meta-data received from the mediation server in order to determine which of the content items to retrieve for storage in the respective content distributor networks.

The mediation server may propagate some or all of the meta-data for the content item to the content distributors(s). The mediation server provides meta-data including at least enough information to enable the content distributor to initiate a request for the content item.

For example, the propagated meta-data may include a location of the content item (e.g., a URL of the content item at the content source), such that the content distributor has sufficient information to request the content item from the content source.

For example, the propagated meta-data may include an identifier of the content item and an identifier of the content source storing the data item, such that the content distributor has sufficient information to request the content item from the content source.

The mediation server may propagate any other meta-data which may be required by or useful to the content distributor, which may be different in different cases depending on the content distributor, the content source, the type of content, and like factors.

The mediation server may propagate meta-data associated with the content item to the content distributor(s) in any format.

In one embodiment, the mediation server generates one or more notification messages for each content distributor to be notified regarding the availability of the content item, and propagates the message(s) to the respective content distributors.

In one such embodiment, the notification message(s) include the meta-data for the content item.

In another such embodiment, the notification message(s) do not include the meta-data for the content item; rather, the notification messages merely trigger the respective content distributor(s) to request the meta-data for the content item. In this embodiment, the content distributor(s) may request the meta-data from the mediation server and/or the content source of the content item.

The notifications and associated meta-data may be formatted in any suitable manner for propagating such information.

The notification of the content distributor(s) regarding availability of the content item, as well as propagation of meta-data for the content item to the content distributor(s), may be performed using any other suitable messaging schemes.

At step 208, method 200 ends. Although depicted and described as ending (for purposes of clarity), it will be understood that the functions of method 200 may continue to be repeated to facilitate distribution of content items from content sources to content distributors.

As described herein, a content distributor, in response to receiving a notification from the mediation server that a content item is available from a content source, obtains the content item and stores the content item within the content distributor network. In this manner, by locating the content item closer to the end user, the content item may be delivered to the end user with minimum delay after user requests (at least because the transport delay may be optimized in that a reduced number of transit nodes and associated buffers must be traversed). As a result, the quality-of-service experienced by end users requesting the content item is improved because the content item is propagated from the local content distributor network serving the end user, rather than from the content source network.

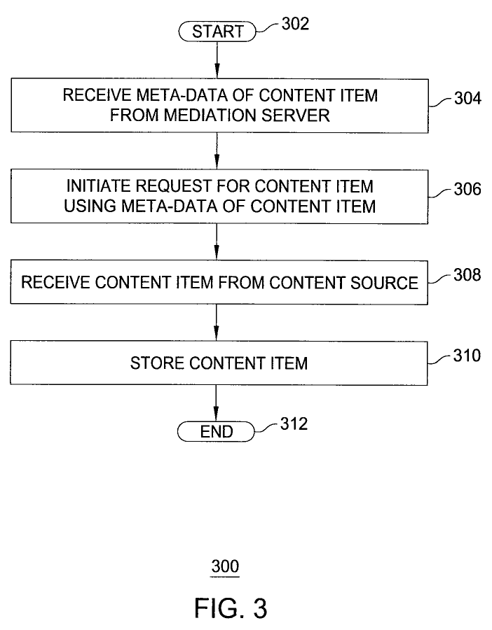

The operation of a content distributor in obtaining and storing a content item in response to a notification from the mediation server that a content item is available from a content source is depicted and described with respect to FIG. 3.

FIG. 3 depicts a method according to one embodiment of the present invention. Specifically, method 300 of FIG. 3 includes a method performed by a content distributor for storing a content item available from a content source. Although primarily depicted and described as being performed serially, at least a portion of the steps of method 300 may be performed contemporaneously, or in a different order than depicted and described with respect to FIG. 3. The method 300 begins at step 302 and proceeds to step 304.

At step 304, the content distributor receives meta-data of the content item from the mediation server.

The meta-data received by the content distributor may include all of the meta-data of the content item or a subset of the meta-data of the content item. The received meta-data includes at least enough information to enable the distribution server to initiate a request for the content item.

For example, the received meta-data may include a location of the content item (e.g., a URL of the content item at the content source), such that the content distributor has sufficient information to request the content item from the content source.

For example, the received meta-data may include an identifier of the content item and an identifier of the content source storing the data item, such that the content distributor has sufficient information to request the content item from the content source.

The received meta-data may include any other meta-data, depending on the needs of the content distributor. For example, the meta-data may include the popularity rating of the content item (e.g., for use by the content distributor in determining where or how to store the content item). For example, the meta-data may include content-based meta-data, which the content distributor may store for use in enabling end users to perform searches for content items.

The content distributor may receive the meta-data of the content item from the mediation server in any manner (e.g., using any of the embodiments depicted and described herein with respect to FIG. 2).

At step 306, the content distributor initiates a request for the content item using the meta-data of the content item.

The content distributor may initiate a request for the content item in any manner suitable for initiating such a request, which may depend on the type of content, the source of the content item, the type of network(s) over which the content item will be provided, and like factors.

For example, the content distributor may initiate an HTTP GET request to a URL provided as part of the meta-data.

For example, the content distributor may initiate a secure connection to a content source server using an IP address of the content source server provided as part of the meta-data, and then request a copy of the content item using a content identifier of the content item also provided as part of the meta-data.

At step 308, the content distributor receives the content item from the content source.

The content distributor may receive the content item in any manner suitable for receiving the content item, which may depend on the type of content, the source of the content item, the type of network(s) over which the content item is provided, the manner in which the content item is requested, and like factors.

For example, the content distributor may receive the content item from the content source over a connection (e.g., a TCP/IP connection) in response to a request initiated by the content distributor for the content item (e.g., a HTTP GET request).

For example, the content distributor may receive the content item from the content source using one or more content streaming protocols.

For example, the content item may be downloaded to the content distributor.

At step 310, the content distributor stores the content item. The content distributor may store the content item on one or more content distributor servers adapted for responding to content requests from end users.

At step 312, method 300 ends. Although depicted and described as ending (for purposes of clarity), it will be understood that the functions of method 300 may continue to be repeated to facilitate retrieval by content distributors of content items from content sources.

Although primarily depicted and described herein with respect to embodiments in which the mediation server notifies a content distributor regarding the availability of a content item from a content source, and the content distributor initiates a process for obtaining and storing the content item, in other embodiments the mediation server may interact with the content source of the content item in a manner for triggering the content source to provide the content item to one or more content distributors selected by the mediation server to receive and store the content item.

As described herein, in addition to facilitating distribution of content items from content sources to content distributors, the mediation server also may facilitate delivery of content usage information from content distributors to content sources, as depicted and described with respect to FIG. 3.

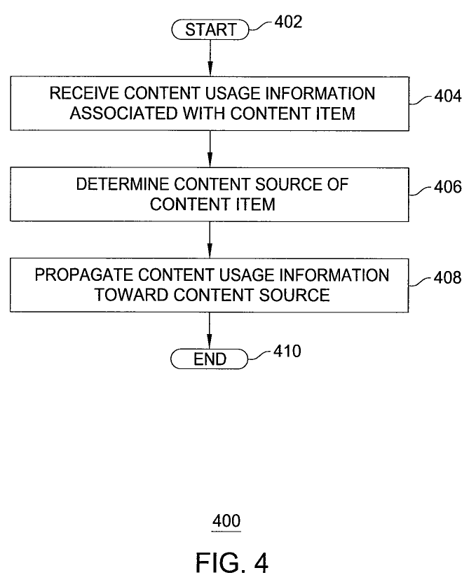

FIG. 4 depicts a method according to one embodiment of the present invention. Specifically, method 400 of FIG. 4 includes a method performed by a mediation server for facilitating delivery of content usage information from one or more content distributors to a content source. Although primarily depicted and described as being performed serially, at least a portion of the steps of method 400 may be performed contemporaneously, or in a different order than depicted and described with respect to FIG. 4. The method 400 begins at step 402 and proceeds to step 404.

At step 404, the mediation server receives content usage information associated with a content item from one or more content distributors.

The content usage information received from a content distributor for a content item may include an identifier of the content item, a title of the content item, a number of times the content item has been provided to end users, distribution-related information associated with delivery of the content item to end users (e.g., time of day, day of week, location, and/or other distribution-related information), service-related information associated with delivery of the content item to end users (e.g., mobile, fixed-line, best-effort, and/or other service-related information), and the like, as well as various combinations thereof.

The content usage information may be received from a content distributor in any manner. For example, the content usage information may be periodically pushed by content distributors, periodically requested by the mediation server, pushed by the content distributors in response to one or more trigger conditions, requested by the mediation server in response to one or more trigger conditions, and the like, as well as various combinations thereof.

At step 406, the mediation server determines the content source of the content item. The mediation server determines the content source of the content item using a portion of the content usage information (e.g., an identifier of the content item, an identifier of the content source included with the content usage information, and the like).

At step 408, the mediation server propagates the content usage information toward the content source.

In one embodiment, the mediation server propagates content usage information toward the content source as it is received.

In one embodiment, the mediation server propagates content usage information toward the content server periodically (e.g., the mediation server collects content usage information received since content usage information was last reported to the content source at the end of the previous period, and reports the collected content usage information for the current period to the content source at the end of the current period.

In one embodiment, the mediation server propagates content usage information toward the content server in response to a trigger condition (e.g., after a threshold amount of content usage information has been received by the mediation server for the content item, in response to a request from the content source, and the like).

The mediation server may propagate the content usage information to the content source in any other suitable manner.

At step 410, method 400 ends. Although depicted and described as ending (for purposes of clarity), it will be understood that the functions of method 400 may continue to be repeated to facilitate propagation of content usage information from content distributors to content sources.

Although primarily depicted and described herein with respect to embodiments in which the mediation server propagates content usage information for individual content items, in other embodiments the mediation server may provide content usage statistics for multiple content items to a content source of the content items as a group.

As described herein, the mediation server may or may not be involved in serving requests for content items initiated by end users.

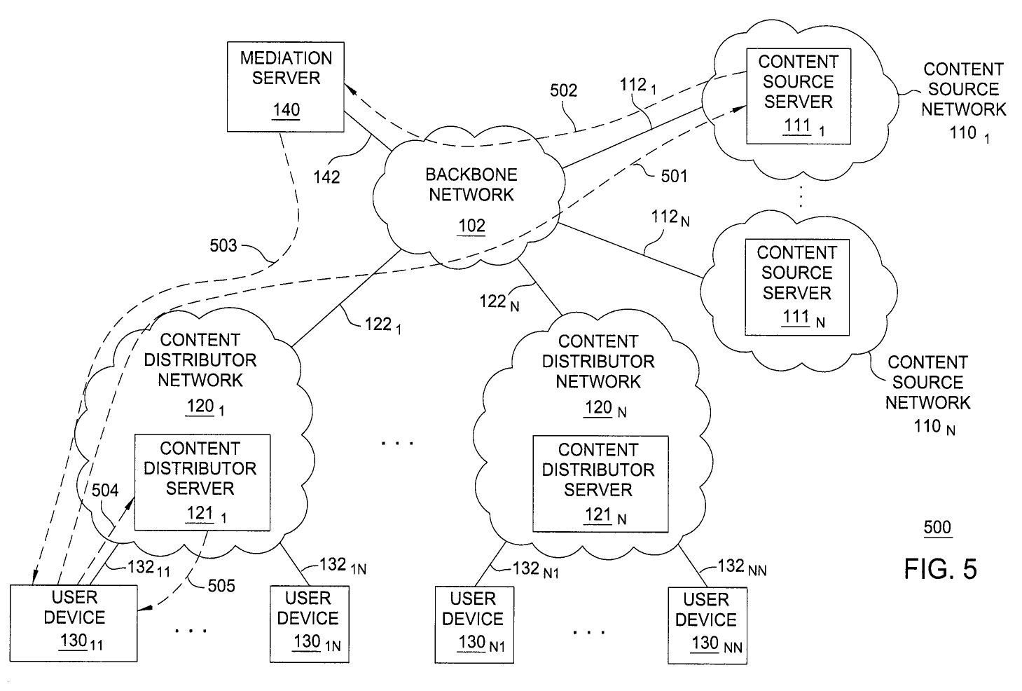

FIG. 5 depicts the communication network of FIG. 1, illustrating an exemplary embodiment of a method for delivering a content item to an end user. As depicted in FIG. 5, an end user using UD 130₁₁ is interested in receiving a content item available from CSN 110₁. In this embodiment, the mediation server participates in delivery of the content item to the end user using UD 130₁₁. The steps performed to enable the end user using UD 130₁₁ to receive the content item from CDN 120₁ are depicted as steps 501-505.

In this exemplary embodiment, assume that, prior to initiation of a request for the content item by the end user via UD 130₁₁, the content source (CSS 111₁) and the content distributor (CDS 121₁) have each registered with MS 140, there is an established relationship between the content source and the content distributor, the content item is available in storage in CSS 111₁ in CSN 110₁, and meta-data for the content item (including a URL specifying the location of the content item on CDS 121₁ in CDN 1201) is stored in MS 140.

At step 501, the end user uses UD 130₁₁ to browse content items available from the content source (e.g., browsing a website hosted on CSS 111₁ or some other device within CSN 110₁). The end user selects the content item that he or she would like to receive.

At step 502, in response to the request from the end user for the content item, CSS 111₁, rather than providing the content item to the end user at UD 130₁₁, informs MS 140 of the request for the content item initiated by the end user at UD 130₁₁.

At step 503, MS 140 identifies the content distribution network that is serving the user device that requested the content item (in this example, CDN 120₁ serving UD 130₁₁), and provides the location of the requested content item within the content distribution network (e.g., the URL of the content item stored on CDS 121₁) to UD 130₁₁.

At step 504, UD 130₁₁ requests the content item from CDS 121₁ of CDN 120₁ from the location of the requested content item received from MS 140. For example, UD 130₁₁ may initiate an HTTP GET request to CDS 121₁ of CDN 120₁ using the URL of the content item received from MS 140.

At step 505, CDS 121₁ of CDN 120₁ propagates the content item to UD 130₁₁. The content item may be propagated to UD 130₁₁ in any manner (e.g., downloaded, streamed, and the like). The UD 130₁₁ receives the content item from CDS 121₁ of CDN 120₁, rather than from CSS 111₁ of CSN 110₁. The UD 130₁₁ may present the content item for immediate viewing by the end user and/or store the content item for later viewing by the end user.

Although depicted and described with respect to an embodiment in which MS 140 provides the specific location of the content item within the content distribution network to UD 130₁₁ (e.g., the URL of the content item stored on CDS 121₁), in another embodiment MS 140 may only provide the UD 130₁₁ with an approximate location of the content within the content distribution network. As an example, MS 140 may inform UD 130₁₁ that the content item is stored on CDS 121₁, but without providing the specific information by which UD 130₁₁ may directly request the content item. As another example, MS 140 may provide the UD 130₁₁ with an IP address, where load-sharing is performed based on the IP address using multiple load-sharing servers operating behind the IP address. The MS 140 may provide the UD 130₁₁ with approximate content location information in various other ways. In at least some such embodiments in which MS 140 provides the UD 130₁₁ with approximate content location information, two additional steps are performed before steps 504 and 505 are performed. In the first additional step, UD 130₁₁ initiates a request to CDS 121₁ for the specific location of the content item (e.g., the URL). In the second additional step, CDS 121₁ responds to the request for the specific location of the content item by providing the specific location of the content item to UD 130₁₁. The steps 504 and 505 described hereinabove may then be performed to enable UD 130₁₁ to obtain the content item from CDS 121₁.

It will be appreciated that method 500 of FIG. 5 may be modified in other ways in order to enable delivery of a content item to an end user.

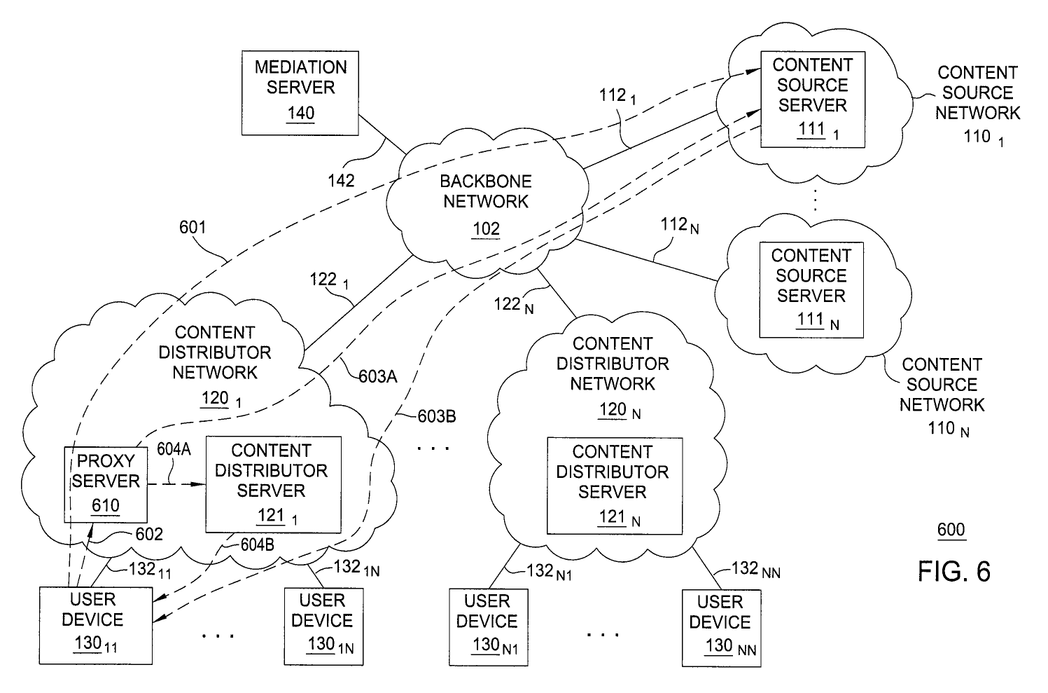

In the exemplary embodiment depicted and described with respect to FIG. 5, the mediation server participates in delivery of content items to end users, however, this is not necessarily required. In other embodiments, such as the exemplary embodiment depicted and described with respect to FIG. 6, the mediation server does not need to participate in delivery of content items to end users.

FIG. 6 depicts the communication network of FIG. 1, illustrating an exemplary embodiment of a method for delivering a content item to an end user. As depicted in FIG. 6, an end user using UD 130₁₁ is interested in receiving a content item available from CSN 110₁. In this embodiment, the mediation server does not participate in delivery of the content item to the end user using UD 130₁₁. The steps performed to enable the end user using UD 130₁₁ to receive the content item from CDN 120₁ are depicted as steps 601-604.

In this exemplary embodiment, assume that, prior to initiation of a request for the content item by the end user via UD 130₁₁, the content source (CSS 111₁) and the content distributor (CDS 121₁) have each registered with MS 140, and there is an established relationship between the content source and the content distributor.

In this exemplary embodiment, further assume that: (1) the CSS 111₁ of CSN 110₁ is capable of operating as an HTTP server; and/or (2) the CDN 120₁ includes a proxy server (illustratively, proxy server 610) capable of snooping and analyzing requests initiated from UD 130₁₁ via CDN 120₁.

At step 601, the end user uses UD 130₁₁ to browse content items available from the content source (e.g., browsing a website hosted on CSS 111₁ or some other device within CSN 110₁). The proxy server 610 may snoop and analyze the interactions between UD 130₁₁ and CSN 110₁.

At step 602, the end user selects the content item that he or she would like to receive, thereby resulting in propagation of a request for the content from UD 130₁₁ toward CSN 110₁. The proxy server 610 snoops and analyzes the request initiated from UD 130₁₁ via CDN 120₁. The proxy server 610 may then direct the request either to CSS 111₁ of CSN 110₁ (illustrated as steps 603) or to CDS 121₁ of CDN 120₁ (illustrated as steps 604), depending on whether the content item has already been cached in CDN 120₁).

At steps 603_{A} and 603_{B}, if the content item has not been stored in CDN 120₁, proxy server 610 directs the request to CSS 111₁, which retrieves the requested content item and propagates the content item to UD 130₁₁. This may or may not result in the content item being stored in CDN 120₁ for subsequent requests from end users served by CDN 120₁. For example, the CDN 120₁ may monitor the number of requests for the content item, and in response to a determination that a current request for the content item satisfies an associated threshold, CDN 120₁ may initiate actions to obtain a copy of the content item to be stored locally in CDN 120₁ for use in serving subsequent requests.

At steps 604_{A} and 604_{B}, if the content item has been stored in CDN 120₁ (e.g., by the processes depicted and described in FIG. 2 and FIG. 3), proxy server 610 directs the request to CDS 121₁, which retrieves the requested content item and propagates the content item to UD 130₁₁.

For steps 603 or steps 604, the content item may be propagated to UD 130₁₁ in any manner (e.g., downloaded, streamed, and the like).

For steps 603 or steps 604, the UD 130₁₁ receives the requested content item, and may present the content item for immediate viewing by the end user and/or store the content item for later viewing by the end user.

As may be seen from these exemplary embodiments, the content item is propagated to UD 130₁₁ locally from CDN 120₁ (rather than from CSN 110₁), thereby improving the quality-of-service experienced by the end user of UD 130₁₁ and, further, reducing the consumption of network resources required to deliver the content item to UD 130₁₁ by obviating the need for CSN 110₁ to deliver the content over BN 102.

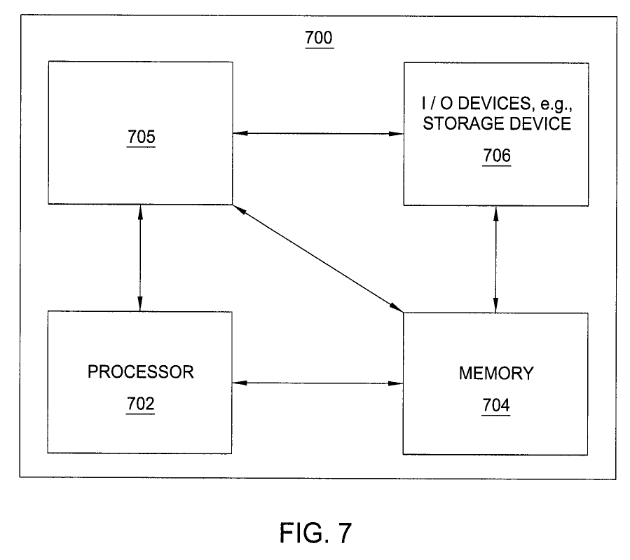

FIG. 7 depicts a high-level block diagram of a general-purpose computer suitable for use in performing the functions described herein. As depicted in FIG. 7, system 700 comprises a processor element 702 (e.g., a CPU), a memory 704, e.g., random access memory (RAM) and/or read only memory (ROM), a mediation control module 705, and various input/output devices 706 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, a microphone, and the like)).

It should be noted that the present invention may be implemented in software and/or in a combination of software and hardware, e.g., using application specific integrated circuits (ASIC), a field programmable gate array (FPGA), a general purpose computer or any other hardware equivalents. In one embodiment, the mediation control process 705 can be loaded into memory 704 and executed by processor 702 to implement the functions as discussed hereinabove. As such, mediation control process 705 (including associated data structures) of the present invention can be stored on a computer readable medium or carrier, e.g., RAM memory, magnetic or optical drive or diskette, and the like.

Although primarily depicted and described herein with respect to embodiments in which content is propagated using specific content transfer capabilities (e.g., content streaming, content downloading, and the like), it will be appreciated that content may be propagated using specific content transfer capabilities.

Although primarily depicted and described herein with respect to embodiments in which the content distribution functions are performed in a centralized manner by a single mediation server, the content distribution functions may be performed in a distributed manner using multiple mediation servers. Although primarily depicted and described herein with respect to embodiments in which the content distribution functions are performed by a mediation server, the content distribution functions may be implemented within one or more existing network elements.

Similarly, although primarily depicted and described herein with respect to embodiments in which the content source networks and content distributor networks include specific numbers and types of network elements, it will be appreciated that the content source networks and content distributor networks may include other numbers and types of network elements.

Additionally, it is contemplated that at least a portion of the described functions may be combined into fewer functional devices. Similarly, it is contemplated that the various functions may be performed by other functional devices, and that the various functions may be distributed across the various functional devices in a different manner.

Additionally, it is contemplated that the signaling/control functions and the content transport functions associated with the content distribution functions depicted and described herein may be implemented using any combination of hardware and/or software. For example, the signaling/control functions and the content transport functions may share hardware and software resources, may use separate hardware and software resources, and the like, as well as various combinations thereof.

Additionally, it is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for facilitating distribution of content from content sources to content distributors, comprising:
receiving, from a content source, meta-data associated with a content item available from the content source; and
propagating, toward a content distributor, a notification regarding availability of the content item from the content source, wherein the notification comprises at least a portion of the associated meta-data.

2. The method of claim 1, wherein the meta-data is received in response to a trigger condition.

3. The method of claim 1, wherein the notification is propagated toward the content distributor in response to at least one of receiving the meta-data from the content source and receiving a polling request from the content distributor.

4. The method of claim 1, wherein, in response to receiving the notification, the content distributor obtains the content item from the content source using at least a portion of the meta-data.

5. The method of claim 1, further comprising:
identifying the content distributor toward which the notification is propagated from a plurality of content distributors.

6. The method of claim 5, wherein identifying the content distributor toward which the notification is propagated from the plurality of content distributors comprises:
identifying each of the plurality of content distributors that has an established relationship with the content source; and
for each content distributor having an established relationship with the content source, determining whether to notify the content distributor regarding the content item.

7. The method of claim 6, wherein, for each content distributor having an established relationship with the content source, determining whether to notify the content distributor regarding the content item is performed using at least a portion of the meta-data of the content item.

8. The method of claim 7, wherein, for each content distributor having an established relationship with the content source, determining whether to notify the content distributor regarding the content item using at least a portion of the meta-data of the content item comprises:
comparing at least a portion of the meta-data of the content item to relationship information defining a relationship between the content source and the content distributor.

9. The method of claim 1, wherein the meta-data comprises at least one of an identifier of the content item, a title of the content item, a location of the content item, an availability of the content item, content-related meta-data for the content item, a geoblocking indicator for the content item, and a popularity indicator for the content item.

10. The method of claim 1, further comprising:
registering the content source using registration information received from the content source;
registering the content distributor using registration information received from the content distributor; and
maintaining information defining a relationship between the content source and the content distributor.

11. The method of claim 1, further comprising:
receiving an indication that the content item has been requested by a user device associated with the content distributor network; and
propagating, toward the user device, content item location information adapted to enable the user device to request the content item from the content distributor network.

12. The method of claim 11, wherein the content item location information comprises a specific location of the content item or an approximate location of the content item.

13. The method of claim 1, further comprising:
receiving content distribution information associated with distribution of the content item to end users; and
propagating the content distribution information toward the content source of the content item.

14. A computer-readable medium storing a software program which, when executed by a computer, causes the computer to perform a method for facilitating distribution of content to end users, the method comprising:
receiving, from a content source, meta-data associated with a content item; and
propagating, toward a content distributor, a notification regarding availability of the content item from the content source, wherein the notification comprises at least a portion of the associated meta-data.

15. The computer-readable medium of claim 14, wherein, in response to receiving the notification, the content distributor obtains the content item from the content source using at least a portion of the meta-data.

16. The computer-readable medium of claim 14, further comprising:
identifying the content distributor toward which the notification is propagated from a plurality of content distributors.

17. The computer-readable medium of claim 16, wherein identifying the content distributor toward which the notification is propagated from the plurality of content distributors comprises:
identifying each of the plurality of content distributors that has an established relationship with the content source; and
for each content distributor having an established relationship with the content source, determining whether to notify the content distributor regarding the content item.

18. The computer-readable medium of claim 17, wherein, for each content distributor having an established relationship with the content source, determining whether to notify the content distributor regarding the content item is performed using at least a portion of the meta-data of the content item.

19. The computer-readable medium of claim 18, wherein, for each content distributor having an established relationship with the content source, determining whether to notify the content distributor regarding the content item using at least a portion of the meta-data of the content item comprises:
comparing at least a portion of the meta-data of the content item to relationship information defining a relationship between the content source and the content distributor.

20. An apparatus for facilitating distribution of content to end users, comprising:
means for receiving, from a content source, meta-data associated with a content item; and
means for propagating, toward a content distributor, a notification regarding availability of the content item from the content source, wherein the notification comprises at least a portion of the associated meta-data.
